(19) United States
(12) Patent Application Publication
(10) Pub. No.: US 2002/0147675 A1
(43) Pub. Date: Oct. 10, 2002

(54) Automated bidding agent for electronic auctions

(75) Inventors: Rajarshi Das, New Rochelle, NY (US); James E. Hanson, Yorktown Heights, NY (US); Jeffrey O. Kephart, Cortlandt Manor, NY (US); Gerald J. Tesauro, Croton-on-Hudson, NY (US)

Correspondence Address: FERENCE & ASSOCIATES, 129 Oakhurst Road, Pittsburgh, PA, 15215, US

(73) Assignee: IBM Corporation, Armonk, NY

(21) Appl. No.: 09/829,701

(22) Filed: Apr. 10, 2001

(51) Int. Cl. G06F 17/60

(52) U.S. Cl. 705/37; 709/203

(57) ABSTRACT

Automatic electronic bidding for goods or services. In one embodiment, the history of bids or asks is examined to determine which have resulted in trades within a prescribed span of time. This information plus, possibly, some additional auxiliary information is used to estimate, for one or more candidate prices within a prescribed range, the likelihood for a bid or ask at that price to result in a trade; an optimal price is selected using this set of bid/ask prices and trade probabilities plus additional information about privately held information about reservation prices, etc. to compute an optimal bid/ask price or modify an existing bid/ask; and the auctioneer is sent a message conveying the chosen new or modified optimal bid/ask price.

### FIELD OF THE INVENTION

The present invention relates generally to electronic auctions and, more particularly, to methods of participating in electronic auctions without requiring human supervision or intervention.

### BACKGROUND OF THE INVENTION

Electronic auctions have become an important element of electronic commerce. On the Internet, numerous sites such as eBay and Amazon host auctions for millions of different items every day, enabling individuals or small businesses to advertise and sell their wares to individual consumers. A large number of electronic marketplace sites, such as esteel and FreeMarkets, facilitate business-to-business auctions electronically.

Electronic auctions automatically execute many, if not all, functions that had historically been assumed by auction houses and auctioneers, including describing the items up for auction, receiving bids, reporting trades and other aspects of market activity to the participants, computing and announcing the winner(s) and the prices at which goods are to be exchanged, etc. By and large, however, it is assumed that the participants in electronic auctions are human, and thus auction sites are almost exclusively oriented towards human participants, and do not cater to the needs of software agents that might wish to participate in the auction. This requires humans to monitor an auction more or less continually, which can be tedious and tiring.

One partial solution is provided by the AuctionBot, an electronic auction server developed by Michael Wellman et al. at the University of Michigan [“The Michigan Internet AuctionBot: A configurable auction server for human and software agents,” P R Wurman, M P Wellman, and W E Walsh, Second International Conference on Autonomous Agents, pages 301-308, May 1998.] While the AuctionBot enables software agents to participate in auctions, it provides no definition or implementation of the software agents themselves, and thus does not of itself offer a complete solution.

A second partial solution to the problem of having to continuously monitor auctions that has been adopted by auction sites like eBay and Amazon is to offer a bidding proxy, which allows the participant to specify beforehand a maximum price that she is willing to bid. The bidding proxy will automatically increment the participant's bid whenever she is outbid, up to the specified maximum price. However, this fails to capture anything approaching the full range of bidding strategies that a user might wish to employ. For instance, a common strategy used by eBay bidders, called “sniping”, is to wait until the last few seconds of an auction and then overbid the current best bid—something that cannot be expressed by the simple proxy offered by eBay.

Another solution has emerged to cater to buyers who wish to snipe. A third party bidding service, such as that currently provided by esnipe.com, allows bidders to specify a snipe price, and esnipe.com will automatically place that bid at a specified moment, typically a few seconds before the close of the auction.

However, even this is an extremely limited type of strategy that does not fully express the range that a buyer might wish to employ. Furthermore, both the proxy bidding and the automated sniping are very specific to the familiar “English ascending auctions”, which represent only one class of a large universe of possible auction types. Particularly in the types of auctions that may well be prevalent in the business-to-business world, different and much more sophisticated bidding strategies may be desired (to relieve tedium) and even required (particularly for complex combinatorial auctions that may require extensive computation on the part of bidders).

Historically, there have been some attempts to experiment with more sophisticated automated bidding strategies than those just described. One branch of this research, represented by the work of Gode and Sunder [“Allocative Efficiency of Markets with Zero Intelligence Traders: Market as a Partial Substitute for Individual Rationality,” D. Gode and S. Sunder, Journal of Political Economy 101, 119-137, 1993], Cliff [“Minimal-Intelligence Agents for Bargaining Behaviors in Market-Based Environments,” David Cliff, Hewlett Packard Laboratory Report HPL-97-91, 1997.] and Gjerstad and Dickhaut [“Price Formation in Double Auctions,” S. Gjerstad and J. Dickhaut, Games and Economic Behavior 22, 1-29, 1998.], seeks to understand the process by which participants, ignorant of one another's valuations for goods, use limited feedback from the auctioneer to arrive at prices that approximate the competitive equilibrium. (The competitive equilibrium is the price at which there is a balance between supply and demand; a rigorous definition can be found in [A. E. Roth and M. A. Oliveira Sotomayor, “Two-sided Matching: A study in game-theoretic modeling and analysis,” Cambridge University Press, Cambridge, 1990, p. 209.) Therefore, the emphasis is on understanding the collective interactions among automated bidding strategies that are intended to approximate human behavior. The emphasis is not on developing superior bidding strategies since, typically, the performance of individual participants is not even measured, let alone optimized. Instead, the measurements are focussed on overall market statistics, such as market efficiency and the dynamics of order and trade prices.

A second branch of research is the “agent bidding tournament”, the prime examples of which are the Santa Fe Double Auction Tournament of 1990 [“The Double Auction Market: Institutions, Theories, and Evidence”, D. Friedman and J. Rust, Addison Wesley, 1992] and the more recent Trading Agent Competition at ICMAS 2000 (the International Conference on Multi-Agent Systems 2000), [Amy Greenwald and Peter Stone, “Autonomous bidding agents in the Trading Agent Competition,” IEEE Internet Computing, April 2001]. Here, the emphasis is on creating individual automated bidders that outperform other automated bidders. The Santa Fe Double Auction tournament presented problems in that it was not a real-time auction: it enforced synchronized bidding of all agents at every time step, and each time step was artificially slowed down to allow agents to calculate and place their bids. The Trading Agent Competition at ICMAS 2000 pitted agents against one another in a realistic, real-time, asynchronous setting. One of the elements of the competition involved a continuous double auction. However, the algorithms entered by the contestants were all rather simplistic; prices were raised or lowered by simple increments until either a trade occurred or an estimated valuation was reached. No effort was made to employ more sophisticated algorithms that base order prices on the observed history of orders and trades.

Gjerstad and Dickhaut, supra, have developed a bidding algorithm (henceforth referred to as “GD”) that bases order prices on the observed history of orders and trades. However, it is narrowly applicable to a very specific type of continuous double auction, in which there is no order queue, i.e., a bid or ask expires as soon as it is bested by another, and furthermore it has only been shown to work when all market participants employ GD.

Therefore, in order to relieve humans from the need for constant vigilance and participation in electronic auctions, and to improve on the gains from trade that can be attained by human traders, a need has been recognized in connection with automating the process of bidding in electronic auctions, and to develop bidding strategies that adapt to market conditions, and to the observed history of orders and trades. A need has also been recognized in connection with providing a broadly applicable and modular method for composing an automated bidder in such a way as to permit it to be easily tuned by its human owner.

### SUMMARY OF THE INVENTION

In accordance with at least one presently preferred embodiment of the present invention, a method, system, apparatus, and computer program product are provided for participating automatically in an electronic auction. In one embodiment, a bidding agent receives from the auctioneer a stream of messages reflecting market activity; aggregates this information into a history of market activity; examines the history of bids or asks to determine which have resulted in trades within a prescribed span of time; uses this information plus (possibly) some additional auxiliary information to estimate, for one or more candidate prices within a prescribed range, the likelihood for a bid or ask at that price to result in a trade; selects an optimal price using this set of bid/ask prices and trade probabilities plus additional information about privately held information about reservation prices, etc. to compute an optimal bid/ask price or modify an existing bid/ask; and sends to the auctioneer a message conveying the chosen new or modified optimal bid/ask price.

It has been found that a process, in accordance with at least one embodiment of the present invention, can outperform humans in the sense of extracting greater gains from trade.

The present invention, in accordance with at least one presently preferred embodiment, greatly extends the range of market rules that can be covered in comparison with the aforementioned GD algorithm, and includes a number of extensions that provide a benefit in comparison with that GD algorithm even for the original, narrower set of market rules for which the latter was designed.

In summary, one aspect of the present invention provides a method of facilitating automatic participation in an electronic auction, the method comprising the steps of: obtaining information relating to an auction; choosing an order computation method; computing an order via executing the chosen order computation method; and placing the computed order.

An additional aspect of the present invention provides a method of facilitating automatic participation in an electronic auction, the method comprising the steps of: obtaining information relating to an ongoing auction; computing an order based on the obtained information; and placing the computed order; wherein the step of computing an order comprises estimating, for one or more candidate prices within a predetermined range, the likelihood for a bid or ask at each price to result in a trade.

A further aspect of the invention provides a method of facilitating automatic participation of an external buyer in an electronic auction, the method comprising the steps of: automatically obtaining information relating to an auction on behalf of an external buyer; automatically computing an order on behalf of the buyer; and automatically placing the computed order on behalf of the buyer.

An additional aspect of the present invention provides an apparatus for facilitating automatic participation in an electronic auction, the apparatus comprising: an arrangement for obtaining information relating to an auction; an arrangement for choosing an order computation method; an arrangement for computing an order via executing the chosen order computation method; and an arrangement for placing the computed order.

A yet additional aspect of the present invention provides an apparatus for facilitating automatic participation in an electronic auction, the apparatus comprising: an arrangement for obtaining information relating to an auction; an arrangement for computing an order based on the obtained information; and an arrangement for placing the computed order; wherein the computing arrangement is adapted to estimate, for one or more candidate prices within a predetermined range, the likelihood for a bid or ask at each price to result in a trade.

A further aspect of the invention provides a program storage device readable by machine, tangibly embodying a program of instructions executable by the machine to perform method steps for facilitating automatic participation in an electronic auction, the method comprising the steps of obtaining information relating to an auction; choosing an order computation method; computing an order via executing the chosen order computation method; and placing the computed order.

A yet further aspect of the present invention provides a program storage device readable by machine, tangibly embodying a program of instructions executable by the machine to perform method steps for facilitating automatic participation in an electronic auction, the method comprising the steps of: obtaining information relating to an ongoing auction; computing an order based on the obtained information; and placing the computed order; wherein the step of computing an order comprises estimating, for one or more candidate prices within a predetermined range, the likelihood for a bid or ask at each price to result in a trade.

Furthermore, an additional aspect of the invention provides a program storage device readable by machine, tangibly embodying a program of instructions executable by the machine to perform method steps for facilitating automatic participation of an external buyer in an electronic auction, the method comprising the steps of: automatically obtaining information relating to an auction on behalf of an external buyer; automatically computing an order on behalf of the buyer; and automatically placing the computed order on behalf of the buyer.

For a better understanding of the present invention, together with other and further features and advantages thereof, reference is made to the following description, taken in conjunction with the accompanying drawings, and the scope of the invention will be pointed out in the appended claims.

### BRIEF DESCRIPTION OF THE DRAWINGS

FIG. 1 schematically illustrates a general computer network.

FIG. 2 is a block diagram of a data processing system that may be implemented as a server.

FIG. 3 is a block diagram of a data processing system which may employ at least one embodiment of the present invention.

FIG. 4 is a block diagram of an automated bidding system.

FIG. 5 is a block diagram of the process by which orders are computed.

FIG. 6 is a block diagram of the process by which the belief function is computed.

### DESCRIPTION OF THE PREFERRED EMBODIMENTS

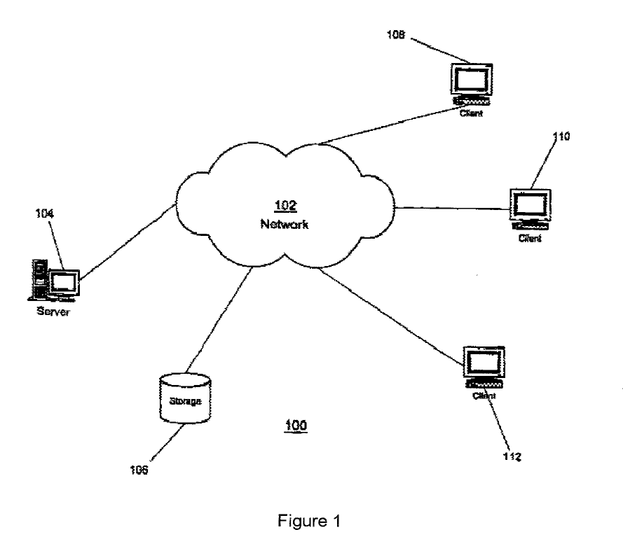

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

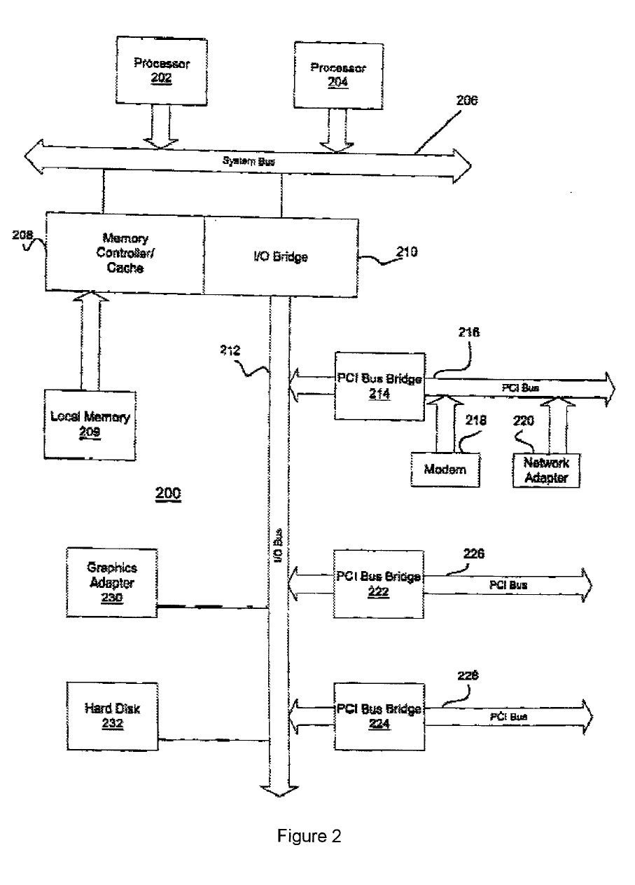

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

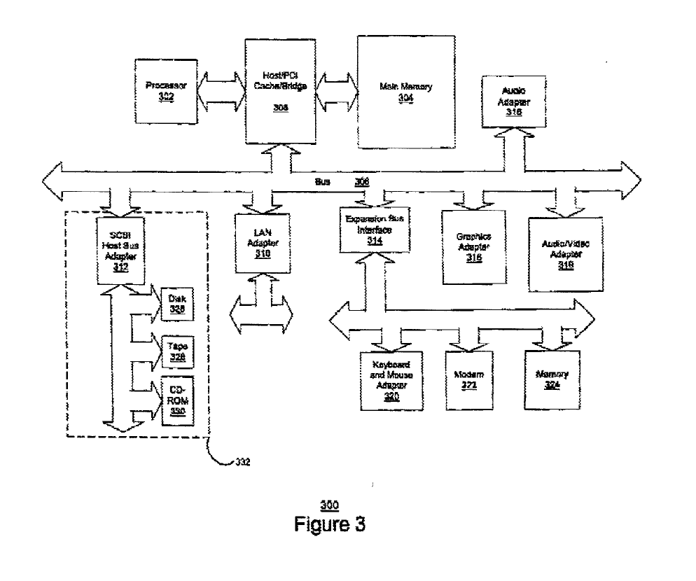

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

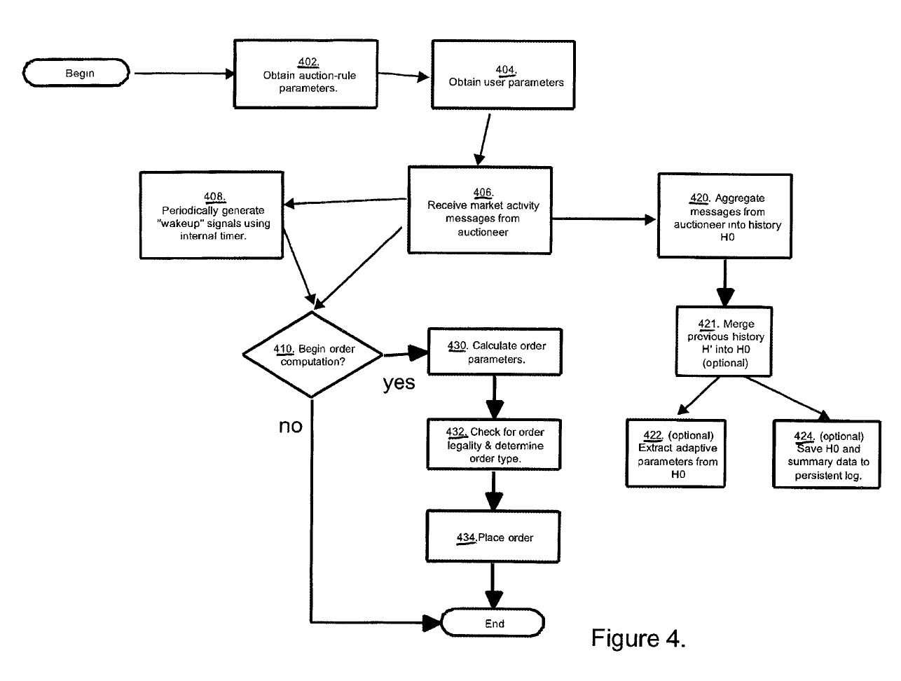

With reference now to FIG. 4, a block diagram illustrating an automated bidding system is depicted in accordance with a preferred embodiment of the present invention. Preferably, the bidding systems shown in FIG. 4 is tailored to a class of auctions known as continuous double auctions, in which one or more buyers may place bids indicating the amount they are willing to pay for a specified number of items being sold at auction, and one or more sellers may place asks indicating the amount for which they are willing to sell a specified number of items. The automated bidding system 400 provides a method and system that automatically receives messages conveying information on market activity from an electronic auctioneer, computes bids or asks automatically, and automatically sends messages conveying the computed bids or asks to the electronic auctioneer.

The system 400 of the present invention receives at step 402 information about the auction rule parameters. These parameters could include the type of auction, e.g. continuous double auction, Dutch auction, English ascending auction, etc., as well as rules governing the legality of particular types of orders under various market conditions. One example of such a legality rule is the spread reduction rule for continuous double auctions, which demands that a new bid or ask improve on the best previous bid or ask. Another type of legality rule is one that specifies whether or not orders may be cancelled or modified. An additional example of a type of rule parameter is one specifying whether or not an order queue is present. The auction rule parameter information could be built into the system 400 if it is dedicated to a single type of auction with a fixed set of rules, or it could be supplied manually by the user, or it could be conveyed by the auctioneer via a message or set of messages. At step 404, which may occur before, after, or concurrently with step 402, the system receives information about the user's parameters. These include an expression of the value to the user of various items or sets of items that might be obtained through the auction, and may also include parameters that influence the behavior of the bidding agent system. In the preferred embodiment, these bidding parameters may be manipulated at will by the user during the operation of the system. Once steps 402 and 404 are complete, the system receives at step 406 a stream of market activity messages from the auctioneer. Typically, among the first such messages is one indicating that the auction has begun, which may launch an internal period “wakeup” signal at step 408, which periodically triggers the computation of orders at a frequency specified by the user or set automatically in response to the observed frequency with which orders are being placed in the market.

At step 420, received messages are aggregated into a history H0 of market activity. While it is an essential element in the computation of the order, H0 is maintained by a process that runs independently of the order computation or placement. In the preferred embodiment, in which the auction is for one or more units of a homogeneous good or service, H0 comprises a list of tuples (i.e., a set of ordered elements) of the form <OrderType, Price, Quantity, OrderStatus, PlacementTime, ClosureTime> that represent data pertaining to a subset of orders that have been placed in the market. Allowed values for OrderType may include Buy, Sell, ModifiedBuy or ModifiedSell, for example. Price is the price at which an order was placed. Quantity is the number of items in the order. (If several different goods or services are being sold at auction, then Quantity must be generalized to identify which types of goods or services are being proposed.) OrderStatus is the current status of the order; allowed values could include Traded, Open, Withdrawn, Expired, Modified, or possibly other values as well, depending on the exact rules of the auction. PlacementTime is the time at which the order was placed, and ClosureTime is the time at which an order ceased to be active, either because it resulted in a trade, or was modified, or withdrawn, or expired, etc. At 420, messages arriving from the auctioneer at 406 that pertain to specific orders are interpreted, and any changes in status are used to update the information in H0. For example, if a message arrives indicating that a particular order has just traded, the tuple representing that order in H0 will have its OrderStatus updated from Open to Traded, and its ClosureTime will be updated from Null to the time at which the trade occurred.

Optionally, at 421, H0 may be augmented with a previous history H′ containing a history of orders and trades from previous auctions. In one embodiment, H′ is obtained from previous versions of H0 that have been collected and saved by the system during previous auctions at step 424. Alternatively, H′ may be obtained from another automated system that has previously participated in the auction. A third alternative is to obtain H′ from the auctioneer. A fourth alternative is to obtain H′ from a third party service that has collected this information, and may offer it for a fee. At 421, a decision is made as to whether to combine H′ with H0, the history of the current auction, and if so how much of H′. In the preferred embodiment, the decision about whether to include H′ is based on an assessment of how likely the order and trade information in H′ is to be relevant to the current auction. Specifically, if the bidding system has recently participated in one or more auctions conducted by the auctioneer that is conducting the current auction, then any activity in H′ that has occurred since the most recent change (or sufficiently significant change) in the user's valuations is merged into H0. This strategy makes the implicit assumption that the user's valuations are likely to be at least somewhat correlated with other participants' valuations, so that constancy in one's own valuations implies relative constancy in other participants' valuations, and therefore in their bidding behavior.

Optionally, at step 422, various adaptive parameters may be derived from H0. These will be described more fully later. Also optional is step 424, in which H0 and summary data derived from it are logged persistently in a data file. This information may be helpful in future auctions.

The order computation and placement cycle is triggered at step 410. Either in response to the receipt of an appropriate message at 406, or in response to a sufficiently significant update to the user parameters at step 404, or as dictated by the internal “wakeup” signal at step 408, or a decision is made at step 410 to start the order and placement cycle, whereupon control passes to step 430. If the cycle is triggered by messages at step 406, a specified subset of messages received from the auctioneer at 406. In the preferred embodiment, a user of the invention is given an opportunity to specify the set of messages that can trigger order computation. These could include just messages reporting a recent trade, or messages reporting a recent order placement, or both types. Additional logic at step 410 can specify how to combine the information from the internal “wakeup” trigger at step 408 and the message-based trigger. For example, the order computation could be triggered whenever the appropriate messages are received or a sufficient amount of time has passed since the last order computation. The logic may also choose to override the trigger, and forego computing an order. For example, the system may have placed a bid too recently to warrant recomputation, or the market state may not have changed sufficiently, or the system may realize that the market message simply reflects its own recent bid, in which case it would be ridiculous to compete against its own bid. If it is decided at 410 to forego computing an order, the system waits to be triggered again by steps 406 or 408.

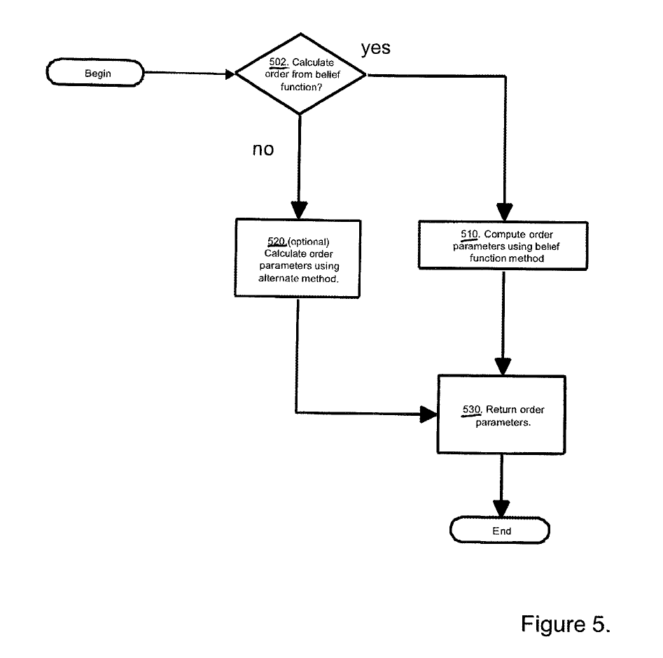

The process of computing and placing an order is represented in FIG. 4 by steps 430, 432, and 434. If it is decided at 410 to compute an order, then the computation is performed at step 430. A detailed description of the order computation step will be provided with reference to FIG. 5. Next, at step 432, the computed order is examined to determine whether it is legal, and if so what should be the type of order, e.g. whether a new or modified order should be placed at that price. (If market rules forbid order modification, but permit bid cancellation, then the same effect can be achieved by canceling the previous order and placing a new one.) For continuous double auctions with a spread reduction rule, the preferred embodiment checks whether the proposed bid exceeds the current best bid, or the proposed ask is less than the current best ask. If not, the order would be rejected by the market rule, so it is not worthwhile to submit it. Therefore in this case the bid computation process terminates. If the proposed order does fall within the spread, a new or modified order will be generated. If the buyer or seller in question has no outstanding bids, then a new order is generated at the proposed price. If the buyer or seller in question has outstanding bids, but their number is less than a threshold defined by the market, then a decision is made as to whether to place a new order—or, if market rules permit orders to be modified, to modify an existing one. If the number of outstanding bids is equal to the threshold, then a decision is made as to which one of the outstanding orders to modify. At step 432, it is also possible to choose not to place an order, even if the computed order can be placed legally. For example, the computed order may have a legal placement as a bid that modifies an existing one by five cents, and this could be deemed too small a difference to justify the trouble of submitting a modified order, particularly if there are transaction costs. Finally, at step 434, the order is placed by formatting it into an appropriate message and sending it to the auctioneer. This completes the process of order computation and placement; the system awaits further signals at steps 406 and 408 before executing another round of this cycle.

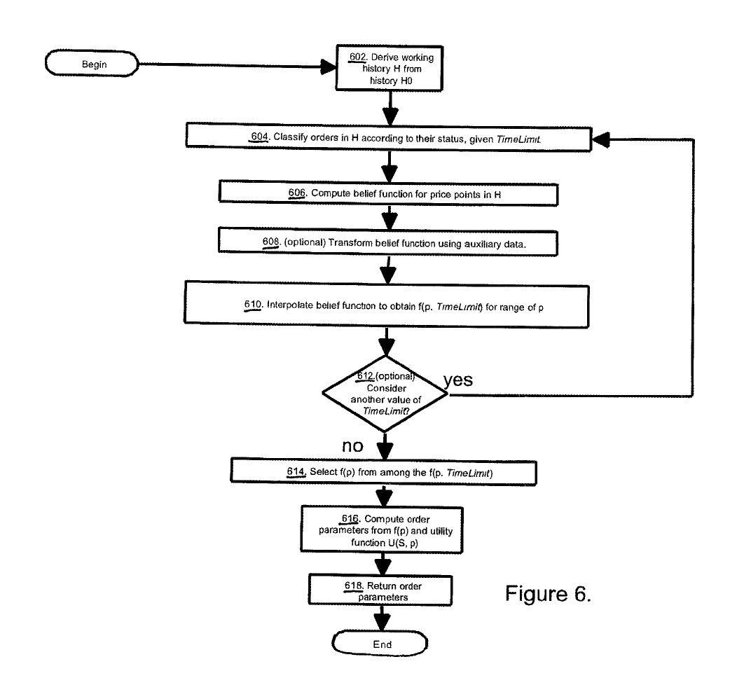

The order computation step 430 is now described in more detail with reference to FIG. 5. First, at step 502, the method to be used to compute the order is determined. The preferred embodiment employs a method based on the estimation of a belief function, which represents the probability for an order to result in a trade within a specified time period as a function of the order price. If at 502 it is decided to use the belief function method, then execution proceeds to step 510, where the order parameters are computed based on the belief function method. This computation will be described more fully with reference to FIG. 6. However, under some circumstances (such as the history H containing an inadequate amount of data) the belief-function approach may not be viable, in which case an alternate method is selected at 502, and executed at step 520.

In the preferred embodiment, the choice of order computation method is based on the size of H0. For example, the belief-function method (step 510) would be executed only if in H0 the number of orders or trades exceeds a specified threshold. (Naturally, any logical combination of these constraints could be employed.) Otherwise, in step 520 an alternative pricing algorithm is used. Among the possibilities are Zero-Intelligence (Gode and Sunder, supra) or Zero-Intelligence Plus (Cliff, supra). Another alternative pricing algorithm that is feasible even if there is no order history H0 at all is to bid an amount that depends solely on the limit prices L(1), L(2), . . . , L(n). For example, the bid could be chosen to yield a surplus that is a fixed amount or percentage of the limit price. A second method is to compute the order price by selecting a price randomly from an interval ranging from L(s) to a specified factor g times L(n). (This assumes that s-1 items have already been obtained.) For sellers, g would typically be greater than 1, while for buyers it would typically be less than 1. The distribution according to which the price is selected within that interval could be selected by the user. In the preferred embodiment, it is a uniform distribution, but it could also be any other sort of distribution, perhaps one that is biased to make the order price more or less aggressive.

Regardless of whether the order parameters were computed via a belief-function method or some other method, the order parameters are returned at step 530, and execution proceeds at step 432.

The computation of the belief function is now described with reference to FIG. 6. Optionally, at 602, H0 may be reduced to a subset H of the full history of market activity. In the preferred embodiment, H only reflects the most recent market activity. Several means for determining the subset are possible. One method is to identify the oldest order that was involved in the mlth most recent trade, where ml is a chosen constant, and include in H0 that order plus all that have been placed thereafter. A second, related alternative extends this as follows. If the number of orders that have not resulted in trades is fewer than m2, then H0 is extended far enough back in time to include m2 orders that have not resulted in trades. A third alternative is to include just the m3 most recent orders. A fourth alternative is to include all orders placed no more than a time t ago. A fifth alternative is to take H to be the full history, i.e. H=H0. Arbitrarily complex logical combinations of these and other alternatives can naturally be envisioned as well.

Next, at 604, for each order in H, examine the status of each order to determine whether it resulted in a successful trade. There are many possible ways to gauge success and failure. The most obvious is to regard an order as having traded successfully if it ever traded, and as a failure otherwise. The current best bid and ask may be excluded from consideration, as they have not yet had a sufficient chance to succeed or fail. This is similar to the method first described by Gjerstad and Dickhaut, supra, and may be appropriate when the market has no order queue, i.e. the auctioneer only keeps a record of the current best bid and best ask, updating them as higher bids or lower asks are received, and matching and erasing them when the best bid equals or exceeds the best ask.

However, the method of Gjerstad and Dickhaut, supra, is inappropriate for an important class of continuous double auctions, in which the auctioneer maintains bid and ask queues such that, when the current best bid is exceeded or the current best ask is undercut, they are not removed, but simply demoted to the second position in their respective queue, with the new bid or ask assuming the first position. Bids or asks that have been pushed down to lower positions in their queues by a succession of higher bids or lower asks may later rise back to the top of their queues when the bids or asks above them are removed through trade, withdrawal, expiration, or possibly other circumstances. In such a case, it is possible to have several orders whose status is “Open”. While these orders have not yet resulted in trades, it would be unfair to regard them as failed, because they still have a chance to result in a successful trade.

To solve this problem, a preferred embodiment of the present invention employs a third alternative criterion for gauging success and failure. An order is regarded as having traded successfully only if the OrderStatus is Traded and ClosureTime−PlacementTime is less than or equal to a specified TimeLimit. The value of TimeLimit may be set manually by the user, or it may be set adaptively in response to the perceived timescale on which the market order queue changes. An order is regarded as Undecided if the OrderStatus is Open and CurrentTime−PlacementTime is less than or equal to TimeLimit. Orders classified as Undecided are ignored in all further processing. Orders satisfying any other condition, such as having an OrderStatus of Modified, Withdrawn, or Expired, or having an OrderStatus of Traded with ClosureTime−PlacementTime>TimeLimit, are regarded as failures.

Next, at 606, a belief functionf(Price), an estimate of the probability for an order at a price of Price to result in a successful trade within TimeLimit, is computed from the list of successful and failed orders in H in any of a number of ways. The simplest alternative, originally introduced by Gjerstad and Dickhaut, supra, is simply to use all of the orders in H, and to weight them equally. More specifically, for each price p at which at least one order was placed, tally the number of successful asks TA(p), the number of successful bids TB(p), the number of failed asks RA(p), and the number of failed bids RB(p). From these, compute the cumulative functions

TAG(p), the number of successful asks at price greater than or equal to p;

TBL(p), the number of successful bids at price less than or equal to p;

RAL(p), the number of failed asks at price greater than or equal to p; and

RBG(p), the number of failed bids at price greater than or equal to p.

Then, for a buyer, compute

f(p)=(TAG(p)+TB(p)+RB(p))/(TAG(p)+TB(p)+RB(p)+RAL(p)).

Correspondingly, for a seller, compute

f(p)=(TBL(p)+TA(p)+RA(p))/(TBL(p)+TA(p)+RA(p)+RBG(p)).

The preferred embodiment employs a second alternative method for computing f(p) from the data derived in step 604. The idea is to replace the simple tallies TA(p), RA(p), TB(p), RB(p), which counted the number of successful and unsuccessful bids and asks at price p, with analogous weighted sums, in which the term representing an order at price p is a weight that depends on how recent the order was. For example, in time-based weighting, the weight would vary from 1 for orders that have just been placed toward zero for very old orders, with the weight decreasing exponentially in CurrentTime−PlacementTime with a chosen rate parameter μ. The rate parameter μ could be set manually by the user, or set adaptively in response to the observed frequency of order placement in the market. In an alternative order-based weighting scheme, the weight would decay exponentially in the number of orders that have been placed since the order in question. Then, having formed the weighted sums TA(p), RA(p), TB(p), RB(p), and the accumulated quantities derived from these tallies, the belief function, could be computed in exactly the way first described by Gjerstad and Dickhaut, as detailed above. This embodiment is preferred to that of Gjerstad and Dickhaut, as in practice it permits older data to influence the belief function when no other data are available for a given price, but it prevents older data from being overly influential when fresher information is available.

Optionally, at step 606, the weighted sums may be augmented by additional terms representing fictitious trades. For example, a seller might well assume that, if it were to place an ask at the current outstanding bid price, this would result in an immediate trade. Thus it could add a fictitious successful ask at this price and at the current time to its history H. Then it would be natural to add 1 to TA(current_outstanding_bid). Correspondingly, a seller might add 1 to TB(current_outstanding_ask). This is the preferred embodiment. However, a reasonable alternative is to generalize this notion of fictitious trade to include the more aggressive assumption that an ask would trade even if it were somewhere in the spread between the best bid and the best ask. We can introduce a “fictitious trade factor” that varies between 0 and 1. At a value of zero, the behavior is exactly as described for the preferred embodiment. At a value of 1, the fictitious trade factor is very optimistic, assuming (for a seller) that an ask would be successful if it were to marginally undercut (by a single unit) the current best ask, and for a buyer assuming that a bid would be successful if it were to marginally outbid the current best bid, with the assumed taken bid or ask varying linearly with the fictitious trade factor. The fictitious trade factor can be set and adjusted manually, or tuned adaptively by the agent. For example, the agent might increase its fictitious trade factor if it believes (based on experience that it can drive a hard bargain, but might decrease it if the end of the period is approaching and it wants to minimize the risk of failing to make a profitable trade.

Optionally, at step 608, the belief function may be transformed using auxiliary data, such as the current outstanding (highest) bid and/or outstanding (lowest) ask prices. For example, a common rule in continuous double auctions known as the “spread reduction rule” automatically rejects bids that are lower than the outstanding bid, or asks that are higher than the outstanding ask. For this particular case, Gjerstad and Dickhaut proposed altering the buyer's belief function by setting f(p) to 0 for all p less than the outstanding bid, and the seller's belief function by setting f(p) to 0 for all p greater than the outstanding ask. The preferred embodiment omits this optional transformation step.

It is likely that the set of prices p for which the belief function f(p) is evaluated in step 606 is only a subset of all possible prices p. Accordingly, in step 610, an interpolation scheme may be used to compute f(p) for any missing values of p, i.e. those prices p at which no orders occurred in H. Many different interpolation schemes can be contemplated. Gjerstad and Dickhaut, supra, proposed the use of cubic spline interpolation, with the derivative set to zero at the “knot” points—the values of p for which f(p) is evaluated in step 606. A variety of other interpolation schemes, including other types of cubic splines and linear interpolation, may be used.

Optionally, steps 604-610 may be iterated over several different values of TimeLimit to obtain a time-dependent belief function f(p,T), which represents the estimated probability for an order at price p to trade within an amount of time T. This information can be of value in more sophisticated implementations of the invention that employ more complex derivations of the order price than are detailed below in step 616. Iteration of steps 604-610 can be achieved at optional step 612 as follows. The set of values of T for which f(p,T) has already been computed is compared with the desired set of values. If there are any values of T for which f(p,T) remains to be computed, one such value is chosen, TimeLimit is set to T, and control returns to step 604. Otherwise, if no values of T remain, control passes to step 614, at which step a decision is made about which value of T to use, say T′, and the resulting function f(p,T′) is taken to be f(p) in the ensuing steps.

Step 616 takes as input the function f(p) computed at step 610 (and possibly selected at step 614) and a utility function U(S,p), and produces as output a bid or ask price p*. For a buyer, the utility function U(S,p) expresses, for each set S of one or more items in which the buyer might be interested, the perceived value to that buyer of obtaining the set S at the price p. The utility function could be time dependent to reflect time-varying supply or demand, or a lesser or greater degree of urgency for buying or selling the good as time passes, but for simplicity the explicit time dependence is omitted in the following discussion. The utility function could be expressed in a number of ways, for example as a lookup table, or as a mathematical function, or as a combination of the two. A simple example of the latter case has been implemented for a continuous double auction of multiple units of a homogeneous good, in which the buyer establishes a table of limit prices L(1), L(2), . . . , L(n), in which L(i) represents the value the buyer places on acquiring i units of the good. Then, since the units are all identical in this case, the set S can simply be characterized by the number of items i, and the utility function U(S,p) can be expressed as a combination of the table L(i) and a simple linear function of the bid price p:

U(i,p)=L(i)−p.

If the buyer's risk preference is taken into account, U(i,p) might be a more complicated nonlinear function of L(i) and p. For sellers, an analogous utility function U(S,p) can express the value to a seller of selling a set S of items at a price p. The seller might for example establish a set of limit prices L(1), L(2), . . . , L(n), with L(i) representing the minimum price for which they would be willing to sell i units of the good. This might well be the cost associated with producing and distributing that many units of the good. Then the marginal utility u(i,p) could be expressed as a combination of the table L(i) and a simple linear function of the ask price p (note that here p is the marginal price of the ith unit, as opposed to the price of the set of units 1 to i):

u(i,p)=p−(L(i)−L(i−1)).

If the seller's risk preference is taken into account, u(i,p) (and hence U(S,p)) could be some more complicated nonlinear function of L(i) and p.

At 616, the belief function f(p) and the utility function U(S,p) may be operated upon in a number of ways to yield the bid/ask price p* In one embodiment, in which multiple units of a homogeneous good are sold and bids and asks can only be placed for single units, p* is the value of p that maximizes the product

f(p)*(U(s+1,P+p)−U(s,P))=f(p)*u(item s+1, p),

where s is the number of items that have already been bought (if a buyer) or sold (if a seller), and P is the total price paid for the s items obtained so far. In the alternative (second) expression above, p* is the price that maximizes the product of the belief function f and the marginal utility u of the (s+1)th item at price p. Another alternative, designed to prevent overly weak bargaining, is to maximize f(p)* u(s′, p), where s′ is greater than the actual item s+1 under consideration. This can make sense when multiple units are potentially being bought. In effect, this looks ahead to future items that will be bought and sold, which are likely to have a lower value, and this prevents caving in too early on price.

More generally, if the items in question are not homogeneous, then the selected bid is for item s* at price p*, with s* and p* selected so as to maximize the product

f(p,s)*(U(P+p, S′)−U(P,S))=f(p,s)* u(p, s|P,S),

where S is the set of items already obtained and P is the total price paid (if a buyer) or charged (if a seller) for them, S′ is the new set of items formed by adding the item s to the set S, and u(p,s|P,S) is the marginal utility of adding the item s at price p to the existing set of items S obtained for a total expenditure of P. This can be further generalized to apply to a combinatorial auction scenario in which multiple items can be included in a single bid. In this case, s* can be generalized from an item to a set of items not yet included in the set S, and the maximization can be performed over sets of items, possibly with some constraint such as a limit on the number of items that may be included in a single bid.

Optionally, the maximization in step 616 could be performed over a restricted range of p. In the preferred embodiment, the range of p over which the maximum is sought is gradually restricted as the auction progresses. Specifically, at a specified amount of time d1 prior to the close of the auction, the range is restricted such that bids or asks are forced to improve on the current best bid or best ask, and at a second specified amount of time d2 prior to the close of the auction the range is restricted so that a buyer submits a bid that matches the best ask, and a seller submits an ask that matches the best bid.

Finally, at step 618, the order parameters are returned, completing steps 530 and 430 in turn, and control then passes to step 432, order placement.

Optionally, the order computation and placement cycle can include the use of feedback to adaptively tune various parameters, such as TimeLimit, d1, d2, m1, m2, the fictitious trade factor, the rate parameter μ, etc. At optional step 422, a separately running process can periodically extract from the order history H0 historical information that allows for intelligent adaptation of these parameters. As an example, the invention might determine that bids and asks are being submitted at a slow rate, in which case it could choose to increase TimeLimit. On the other hand, in markets with mostly autonomous computer agents, bids and asks will be submitted at a fast rate, and the invention in step 422 could opt to decrease TimeLimit. Similarly, in step 422 the fictitious trade factor might be selected to be compatible with the average rate with which the spread has been observed to be reduced in the past, according to information derived from H0.

The various alternative choices for parameters, distributions, and methods within each of the steps defined in FIG. 4 may be selected manually by users, and altered dynamically during the course of an auction if so desired by the user. Indeed, one of the advantages of this invention is the structuring of the steps defined above, which support flexibility and configurability.

Though processes in accordance with at least one embodiment of the present invention have been described and addressed hereinabove in the context of double auctions, it is to be understood that similar principles may be employed in connection with other types of auctions, such as iterated combinatorial auctions, in which participants submit bids for specific combinations of goods, and the auctioneer makes a final determination of winners and prices after a series of rounds [see, for example, “Iterative combinatorial auctions: Theory and practice”, David C. Parkes and Lyle H. Ungar, in Proc. 17th National Conference on Artificial Intelligence (AAAI-00), 74-81, 2000].

Finally, it should be noted that the process described in FIG. 4 can be employed in several ways. It could be integrated into a buyer's automated procurement system, or a seller's automated sales system. It could also be offered as a third party service. This can easily be distinguished from esnipe.com's service in that it does not just place a fixed order at a pre-specified time. Rather, it automatically determines both the order's timing and its price, and possibly the quantity of the good or service as well. The service would presumably be offered to buyers and or sellers for a fee.

It is to be understood that the present invention, in accordance with at least one presently preferred embodiment, includes an arrangement for obtaining information relating to an auction; an arrangement for choosing an order computation method; an arrangement for computing an order via executing the chosen order computation method; and an arrangement for placing the computed order. Together, the obtaining arrangement, choosing arrangement, computing arrangement and placing arrangement may be implemented on at least one general-purpose computer running suitable software programs. These may also be implemented on at least one Integrated Circuit or part of at least one Integrated Circuit. Thus, it is to be understood that the invention may be implemented in hardware, software, or a combination of both.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method of facilitating automatic participation in an electronic auction, said method comprising the steps of:
obtaining information relating to an auction;
choosing an order computation method;
computing an order via executing the chosen order computation method; and
placing the computed order.

2. The method according to claim 1, wherein said steps of choosing, computing and placing are repeated at least one more time, whereby at least one revised order is computed and placed.

3. The method according to claim 1, wherein said steps of choosing, computing and placing are performed periodically.

4. The method according to claim 3, wherein periodic execution of said choosing, executing and placing steps is triggered by at least one of: a periodic wakeup signal, receipt of an appropriate market activity message, and a sufficient change in parameters relating to a user.

5. The method according to claim 1, wherein said step of obtaining information comprises obtaining information about the auction type and auction rules relating to an auction.

6. The method according to claim 5, wherein said choosing step comprises choosing an order computation method appropriate to the auction type and auction rules.

7. The method according to claim 5, wherein said step of obtaining information relating to the auction type and auction rules comprises obtaining information relating to the auction type and auction rules from an auctioneer via at least one message.

8. The method according to claim 7, further comprising the step of initiating a prompt for performing said step of obtaining information from an auctioneer.

9. The method according to claim 5, wherein said step of obtaining information relating to the auction type and auction rules comprises obtaining information about the existence or absence of an order queue.

10. The method according to claim 1, wherein said step of obtaining information comprises:
obtaining information about parameters relating to a user; and
obtaining information about an ongoing auction.

11. The method according to claim 10, wherein said computing step comprises executing the chosen order computation method while taking into account the parameters relating to a user and the information relating to the ongoing auction.

12. The method according to claim 10, wherein said step of obtaining information relating to the parameters of a user comprises obtaining limit prices relating to the user.

13. The method according to claim 10, wherein said step of obtaining information relating to the parameters of a user is performed prior to the beginning of an auction.

14. The method according to claim 1, wherein said step of obtaining information comprises obtaining information from an auctioneer relating to market activity.

15. The method according to claim 1, further comprising the step of receiving periodic prompts to consider the computation of an order.

16. The method according to claim 1, further comprising the step of deciding on the viability of computing an order prior to said step of computing an order.

17. The method according to claim 1, wherein said step of computing an order comprises the step of ascertaining the legality of the order.

18. The method according to claim 1, wherein said step of computing an order comprises computing a belief function.

19. The method according to claim 7, wherein said step of computing a belief function comprises estimating, for one or more candidate prices within a predetermined range, the likelihood for a bid or ask at each price to result in a trade.

20. The method according to claim 1, wherein said choosing step comprises ascertaining the viability of computing an order via computing a belief function.

21. The method according to claim 1, wherein said step of obtaining information comprises obtaining a history of market activity.

22. The method according to claim 1, further comprising the step of aggregating the information relating to an ongoing auction into a market history.

23. The method according to claim 22, further comprising the step of augmenting the market history with historical information from one or more previous auctions.

24. A method of facilitating automatic participation in an electronic auction, said method comprising the steps of:
obtaining information relating to an ongoing auction;
computing an order based on the obtained information; and
placing the computed order;
wherein said step of computing an order comprises estimating, for one or more candidate prices within a predetermined range, the likelihood for a bid or ask at each price to result in a trade.

25. A method of facilitating automatic participation of an external buyer in an electronic auction, said method comprising the steps of:
automatically obtaining information relating to an auction on behalf of an external buyer;
automatically computing an order on behalf of the buyer; and
automatically placing the computed order on behalf of the buyer.

26. The method according to claim 25, further comprising the step of:
choosing an order computation method;
wherein said computing step comprises computing an order via executing the chosen order computation method.

27. An apparatus for facilitating automatic participation in an electronic auction, said apparatus comprising:
an arrangement for obtaining information relating to an auction;
an arrangement for choosing an order computation method;
an arrangement for computing an order via executing the chosen order computation method; and
an arrangement for placing the computed order.

28. The apparatus according to claim 27, further comprising an arrangement for triggering periodic execution of said choosing, executing and placing steps.

29. The apparatus according to claim 28, wherein said triggering arrangement is adapted to trigger via at least one of: a periodic wakeup signal, receipt of an appropriate market activity message, and a sufficient change in parameters relating to a user.

30. The apparatus according to claim 27, wherein obtaining arrangement is adapted to obtain information about the auction type and auction rules relating to an auction.

31. The apparatus according to claim 30, wherein said choosing arrangement is adapted to choose an order computation method appropriate to the auction type and auction rules.

32. The apparatus according to claim 30, wherein said obtaining arrangement is adapted to obtain information relating to the auction type and auction rules from an auctioneer via at least one message.

33. The apparatus according to claim 32, further comprising an arrangement for initiating a prompt to obtain information from an auctioneer.

34. The apparatus according to claim 30, wherein said obtaining arrangement is adapted to obtaining information about the existence or absence of an order queue.

35. The apparatus according to claim 27, wherein obtaining arrangement is adapted to:
obtain information about parameters relating to a user; and
obtain information about an ongoing auction.

36. The apparatus according to claim 35, wherein said computing arrangement is adapted to execute the chosen order computation method while taking into account the parameters relating to a user and the information relating to the ongoing auction.

37. The apparatus according to claim 35, wherein said obtaining arrangement is adapted to obtain limit prices relating to the user.

38. The apparatus according to claim 27, wherein said obtaining arrangement is adapted to obtain information from an auctioneer relating to market activity.

39. The apparatus according to claim 27, further comprising an arrangement for deciding on the viability of computing an order prior to computing an order.

40. The apparatus according to claim 27, wherein said computing arrangement is adapted to ascertain the legality of an order.

41. The apparatus according to claim 27, wherein said computing arrangement is adapted to compute a belief function.

42. The apparatus according to claim 27, wherein said choosing arrangement is adapted to ascertain the viability of computing an order via computing a belief function.

43. The apparatus according to claim 27, wherein said obtaining arrangement is adapted to obtain a history of market activity.

44. The apparatus according to claim 27, further comprising an arrangement for aggregating the information relating to an ongoing auction into a market history.

45. The apparatus according to claim 44, further comprising an arrangement for augmenting the market history with historical information from one or more previous auctions.

46. An apparatus for facilitating automatic participation in an electronic auction, said apparatus comprising:
an arrangement for obtaining information relating to an auction;
an arrangement for computing an order based on the obtained information; and
an arrangement for placing the computed order;
wherein said computing arrangement is adapted to estimate, for one or more candidate prices within a predetermined range, the likelihood for a bid or ask at each price to result in a trade.

47. A program storage device readable by machine, tangibly embodying a program of instructions executable by the machine to perform method steps for facilitating automatic participation in an electronic auction, said method comprising the steps of:
obtaining information relating to an auction;
choosing an order computation method;
computing an order via executing the chosen order computation method; and
placing the computed order.

48. A program storage device readable by machine, tangibly embodying a program of instructions executable by the machine to perform method steps for facilitating automatic participation in an electronic auction, said method comprising the steps of: obtaining information relating to an ongoing auction;
computing an order based on the obtained information; and
placing the computed order;
wherein said step of computing an order comprises estimating, for one or more candidate prices within a predetermined range, the likelihood for a bid or ask at each price to result in a trade.

49. A program storage device readable by machine, tangibly embodying a program of instructions executable by the machine to perform method steps for facilitating automatic participation of an external buyer in an electronic auction, said method comprising the steps of:
automatically obtaining information relating to an auction on behalf of an external buyer;
automatically computing an order on behalf of the buyer; and
automatically placing the computed order on behalf of the buyer.
